(19) United States
(12) Patent Application Publication
(10) Pub. No.: US 2003/0210830 A1
(43) Pub. Date: Nov. 13, 2003

(54) Image signal distortion removal apparatus, and image signal distortion removal method

(75) Inventor: Hiroyuki Goto, Takatsuki-shi (JP)

Correspondence Address: PARKHURST & WENDEL, L.L.P., 1421 PRINCE STREET, SUITE 210, ALEXANDRIA, VA, 22314-2805, US

(73) Assignee: MATSUSHITA ELEC. IND. CO. LTD., Kadoma-shi (JP)

(21) Appl. No.: 10/419,988

(22) Filed: Apr. 22, 2003

(30) Foreign Application Priority Data
Apr. 22, 2002 (JP) 2002-119602

(51) Int. Cl. G06K 9/40

(52) U.S. Cl. 382/268

(57) ABSTRACT

There is provided an image signal distortion removal apparatus which performs a distortion removal process for removing distortion attendant on decoding of an image signal, and vertical and horizontal filtering processes for the image signal, wherein a control circuit for performing the distortion removal process and the vertical filter process in block units is introduced. Thereby, the processing amount in the distortion removal process, which increases with an increase in the number of taps of the vertical filter, can be reduced.

### FIELD OF THE INVENTION

The present invention relates to an apparatus and a method for performing a distortion removal process of removing distortion attendant on decoding of a coded image signal, and a filtering process of filtering the image signal in the vertical direction and the horizontal direction.

### BACKGROUND OF THE INVENTION

When various kinds of signals such as image signals and acoustic signals are transmitted, recorded, or reproduced as digital signals, a technique for compressing and decompressing the amount of data is employed. Further, when the amount of data of an image is compressed, orthogonal transformation such as discrete cosine transformation (DCT) utilizing correlation between frames is commonly employed. For example, image data coding methods (MPEG1, MPEG2, etc.) which are proposed by MPEG (Moving Picture Coding Expert Group) employ two-dimensional DCT.

The above-mentioned orthogonal transformation is performed for predetermined image blocks of an image signal, and outputted DCT coefficients are quantized block by block. While the coded image signal is decoded by an inverse operation to the coding process, the coded image signal includes an error caused by quantization in the coding process. This quantization error causes distortion (e.g., mosquito noise or block noise) in the decoded image. In order to correctly detect and remove distortion of the decoded image, it is necessary to perform a distortion removal process for removing distortion attendant on the decoding process before various kinds of filtering processes such as filtering for changing the image size (i.e., immediately after the decoding process).

The distortion removal process may be carried out simultaneously with the decoding process, or after the decoding process. In the case where the distortion removal process is performed simultaneously with the decoding process, although the distortion removal process can be effectively carried out by using decoding information, the process is complicated, resulting in an increase in the processing amount (refer to Japanese Published Patent Application No. Hei. 8-149471).

On the other hand, in the case where the distortion removal process is performed after the decoding process, since the process is performed for the decoded image signal without using decoding information, the processing amount can be reduced.

In the distortion removal process performed after the decoding process, image distortion is detected according to whether a difference value between adjacent pixels exceeds a threshold value or not, and a pixel in which distortion is detected is subjected to filtering.

Hereinafter, a description will be given of a conventional image signal distortion removal apparatus which performs a distortion removal process for removing distortion attendant on decoding of a coded video signal, and a filtering process for filtering the image signal in the vertical direction and the horizontal direction, with reference to FIG. 13.

In FIG. 13, reference numeral 1300 denotes an original image memory for storing a decoded original image signal. The original image memory 1300 is constituted as an external memory of the image signal distortion removal apparatus. Reference numeral 1307 denotes a line memory for storing plural lines of image signals as many as the number of taps from the original image memory 1300 to a vertical filter circuit 1302. The line memory 1307 is constituted as an internal memory of the image signal distortion removal apparatus. Reference numeral 1301 denotes a distortion removal circuit comprising plural distortion removal circuits 1˜N as many as the number of taps of the vertical filter circuit 1302. The distortion removal circuit 1301 performs distortion removal for each of the image signals which are read from the line memory 1307 in line units. Reference numeral 1302 denotes a vertical filter circuit which performs vertical filtering for each of the image signals that have been subjected to the distortion removal process by the distortion removal circuit 1301. Reference numeral 1303 denotes a horizontal filter circuit which performs horizontal filtering for each of the image signals that have been vertically filtered. Reference numeral 1304 denotes an image signal transfer circuit which outputs a transfer signal instructing the original image memory 1300 to read a predetermined image signal from among the stored original image signals, and output it to the line memory 1307 in synchronization with a horizontal sync signal. Reference numeral 1305 denotes a vertical filter coefficient generator which generates filter coefficients to be used by the vertical filter circuit 1302. Reference numeral 1306 denotes a horizontal filter coefficient generator which generates filter coefficients to be used by the horizontal filter circuit 1303.

The distortion removal circuit 1301, the vertical filter circuit 1302, and the horizontal filter circuit 1303 process the input image signals in line units.

Hereinafter, the operation of the conventional image signal distortion removal apparatus constructed as described above will be described.

Initially, the original image signal stored in the original image memory 1300 is transferred to the line memory 1307 in accordance with an instruction from the image signal transfer circuit 1304. The image signal transferred to the line memory 1307 is output to the distortion removal circuit 1301 in line units to be subjected to distortion removal. Since the image signal distortion removal apparatus is needed to output one line of image signal in synchronization with the horizontal sync signal, the distortion removal circuit 1301 performs distortion removal in synchronization with the horizontal sync signal. Therefore, the image signal transfer circuit 1304 transfers the original image signal stored in the original image memory 1300 to the line memory 1307 in synchronization with the horizontal sync signal. Further, in order to output the image signal without interruption, the line memory 1307 is constructed so as to have a capacity of one line for each of the distortion removal circuits 1˜N, that is, a capacity of N lines in total.

The distortion removal process will be described in detail with reference to FIG. 14.

Initially, distortion removal for the original image signal is started in line units (S1401). A distortion removal target position is managed in the distortion removal circuit 1301, and a target line position is set at the start of distortion removal (S1402). The target position means a line position, and this line position is used for judgement as to whether or not the line position crosses a DCT block boundary in the vertical direction.

Thereafter, the image signal at the target line position that is set in step 51402 is subjected to distortion detection in synchronization with the horizontal sync signal (S1403) and distortion removal (S1404) until the processing for one line is completed (S1405). When the distortion removal for one line is completed (S1406), the distortion-removed image signal is output to the vertical filter circuit 1302.

When there are unprocessed lines remaining, the target line position is updated, and the remaining unprocessed lines are subjected to similar processing in line units. The target line position is initialized by an input of a vertical sync signal.

Further, when distortion removal is carried out with reference to a result of distortion detection within a DCT block that is a processing unit of inverse DCT, it is necessary to hold a result of distortion detection for plural lines according to the DCT block. For example, when the DCT block comprises 8 lines×8 pixels, a result of distortion detection for maximum 8 lines must be held. The result of distortion detection to be required in the distortion removal process is information obtained by, for example, judging as to whether a difference value between adjacent pixels exceeds a threshold value or not.

The distortion-removed image signal is filtered by the vertical filter circuit 1302 and the horizontal filter circuit 1303, respectively, and output to the outside.

However, since the distortion removal circuit 1301 of the conventional image signal distortion removal apparatus shown in FIG. 13 processes the image signal in line units, it should process plural lines as many as the number of taps of the vertical filter circuit 1302. Therefore, processing overhead occurs every time the target lines are changed, whereby the processing amount of the distortion removal circuit 1301 increases. For example, when the vertical filter circuit 1302 has four taps, the distortion removal circuit 1301 should process four lines every time one line of image signal is output, whereby the processing amount is increased by four times. Accordingly, the processing amount of the distortion removal circuit 1301 increases with an increase in the number of taps of the vertical filter circuit 1302. Because of such increase in the processing amount, duplicate circuits such as the distortion removal circuits 1˜N are needed, resulting in an increase in the circuit scale of the image signal distortion removal apparatus.

Furthermore, the image signal read from the original image memory 1300 in synchronization with the horizontal sync signal of the output image is stored in the line memory 1307 which is an internal memory of the image signal distortion removal apparatus. Since this image signal is consumed by the distortion removal circuit 1301, a capacity for one line is needed in the vertical direction of the image signal. Further, the line memory 1307 needs a capacity for lines as many as the number of taps of the vertical filter circuit 1302, line the distortion removal circuit 1301. For example, when the vertical filter circuit 1302 has four taps, the line memory 1307 needs a capacity for four lines. Accordingly, the capacity of the line memory 1307 constituted as an internal memory is increased in accordance with the number of taps of the vertical filter circuit 1302, resulting in an increase in the circuit scale of the image signal distortion removal apparatus.

### SUMMARY OF THE INVENTION

The present invention is made to solve the above-described problems and has for its object to provide an image signal distortion removal apparatus and an image signal distortion removal method, which enable efficient distortion removal to be performed after decoding, reduce the capacity of an internal memory, and reduce the processing amount.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, there is provided an image signal distortion removal apparatus for removing distortion attendant on decoding from a decoded original image, comprising: an original image memory for storing the original image; a first block memory for storing an image signal read from the original image memory in block units; a distortion removal circuit for performing distortion removal in block units for the image signal read from the first block memory; a distortion removal control circuit for controlling the readout of the image signal from the original image memory to the first block memory, and the distortion removal by the distortion removal circuit; a vertical filter circuit for performing vertical filtering in block units for the output signal of the distortion removal circuit; a second block memory for storing one block of output signal from the vertical filter circuit; an image memory for storing one frame of output signal from the vertical filter circuit; a vertical filter control circuit for controlling the vertical filtering by the vertical filter circuit, and the transfer of the image signal from the second block memory to the image memory; a line memory for storing one horizontal line of image signal read from the image memory; a horizontal filter circuit for performing horizontal filtering in line units for the image signal stored in the line memory; and a horizontal filter control circuit for controlling the readout of the image signal from the image memory, and the horizontal filtering by the horizontal filter circuit. Therefore, the processing amount in the distortion removal process and the internal memory capacity are significantly reduced, whereby the circuit scale of the image signal distortion removal apparatus can be reduced.

According to a second aspect of the present invention, the image signal distortion removal apparatus according to the first aspect further comprises a buffer memory for storing a part of the output signal from the distortion removal circuit as a reference image, the buffer memory being placed between the distortion removal circuit and the vertical filter circuit; wherein the vertical filter circuit performs vertical filtering for an image signal obtained by combining the output signal from the distortion removal circuit and the reference image stored in the buffer memory. Therefore, occurrence of overhead in the distortion removal process can be completely avoided.

According to a third aspect of the present invention, in the image signal distortion removal apparatus according to the first or second aspect, the distortion removal control circuit instructs the original image memory to read a block comprising N×M pixels (N,M: natural numbers) in the horizontal direction, and input the block into the first block memory. Therefore, the image signal distortion removal process can be carried out in block units each comprising N×M pixels.

According to a fourth aspect of the present invention, in the image signal distortion removal apparatus according to the second embodiment, the distortion removal control circuit instructs the original image memory to road an image block comprising a DCT block which is a processing unit of discrete cosine transformation in the decoding process from the original image in the vertical direction, and input the block into the first block memory. Therefore, the distortion removal process can be carried out in DCT block units, whereby it becomes unnecessary to store or refer to the result of distortion detection, resulting in a reduction in the size of the distortion removal circuit.

According to a fifth aspect of the present invention, in the image signal distortion removal apparatus according to the second aspect, the distortion removal control circuit determines a processing area so that the original image is divided into the processing area and a non-processing area in the vertical direction, instructs the distortion removal circuit to successively perform distortion removal in block units each comprising N×M pixels (N,M: natural numbers) in the vertical direction, and outputs a distortion removal end signal to the vertical filter control circuit when the distortion removal within the processing area is ended. Therefore, the capacity of the buffer memory can be reduced.

According to a sixth aspect of the present invention, in the image signal distortion removal apparatus according to the fifth aspect, the distortion removal control circuit determines a processing area in the original image on the basis of the progress of the decoding process. Therefore, overhead in the distortion removal process can be minimized.

According to a seventh aspect of the present invention, in the image signal distortion removal apparatus according to the fifth or sixth aspect, the vertical filter control circuit outputs a vertical filtering end signal to the horizontal filter control circuit when vertical filtering for the image signal in the processing area is ended; on receipt of the vertical filtering end signal, the horizontal filter control circuit instructs the image memory to read the stored image signal in line units, and input it to the horizontal filter circuit; and the distortion removal control circuit determines a new processing area in the original image corresponding to the non-processing area on the basis of the progress of the decoding process, and instructs the original image memory to read the image signal in the processing area in block units in the vertical direction, and input it to the distortion removal circuit. Therefore, when the progress of the decoding process is slow, adverse effect such as interruption of the output image can be avoided.

According to an eighth aspect of the present invention, there is provided an image signal distortion removal method for removing distortion from a decoded image signal which is stored in an original image memory, comprising; a distortion removal step of reading the image signal from the original image memory in block units, and performing distortion removal from the image signal; a vertical filtering step of filtering the distortion-removed image signal in the vertical direction, and storing the image signal into an image memory; and a horizontal filtering step of reading the image signal stored in the image memory in line units, vertically filtering the image signal, and outputting the vertically-filtered image signal as an output image signal. Therefore, the processing amount in the distortion removal process can be significantly reduced.

According to a ninth aspect of the present invention, the image signal distortion removal method according to the eighth aspect further comprises a step of storing a part of the distortion-removed image signal as a reference image into a buffer memory; wherein the vertical filtering step performs vertical filtering for an image signal obtained by combining the distortion-removed image signal and the reference image. Therefore, occurrence of overhead in the distortion removal process can be completely avoided.

According to a tenth aspect of the present invention, in the image signal distortion removal method according to the eighth or ninth aspect, the distortion removal step includes a readout step of reading a block comprising N×M pixels (N,M: natural numbers) as a processing target block from the original image memory in the vertical direction; a position detection step of detecting the position of the processing target block in the original image; a distortion detection step of detecting distortion of the image signal corresponding to the processing target block; and a distortion removal step of removing the detected distortion of the image signal from the processing target block with reference to the detected position of the processing target block. Therefore, the image signal distortion removal process can be carried out in block units each comprising N×M pixels.

According to an eleventh aspect of the present invention, in the image signal distortion removal method according to the ninth aspect, the distortion removal step includes: a readout step of reading a DCT block which is a processing unit of discrete cosine transformation in the decoding process, as a processing target block, from the original image memory in the horizontal direction; a position detection step of detecting the position of the processing target block in the original image; a distortion detection step of detecting distortion of the image signal corresponding to the processing target block; and a distortion removal step of removing the detected distortion of the image signal from the processing target block with reference to the detected position of the processing target block. Therefore, the distortion removal process can be carried out in DCT block units, whereby it becomes unnecessary to store or refer to the result of distortion detection, resulting in a reduction in the processing amount in the image signal distortion removal process.

According to a twelfth aspect of the present invention, in the image signal distortion removal method according to the ninth aspect, the distortion removal step includes a processing area determination step of determining a processing area so that the original image is divided into the processing area and a non-processing area in the vertical direction; and an intra-processing-area distortion removal step of performing distortion removal in block units, within the processing area in the vertical direction. Therefore, the capacity of the buffer memory can be reduced.

According to a thirteenth aspect of the present invention, in the image signal distortion removal method according to the twelfth aspect, the processing area determination step determines a processing area in the original image on the basis of information relating to the progress of the decoding process. Therefore, overhead in the distortion removal process can be minimized.

According to a fourteenth aspect of the present invention, in the image signal distortion removal method according to the twelfth or thirteenth aspect, wherein the distortion removal step performs horizontal filtering for the image signal in the processing area which has been subjected to distortion removal and vertical filtering and, simultaneously, determines a new processing area in the non-processing area on the basis of the progress of the decoding process, and performs distortion removal and vertical filtering for the new processing area. Therefore, when the progress of the decoding process is slow, adverse effect such as interruption of the output image can be avoided.

According to a fifteenth aspect of the present invention, there is provided an image signal distortion removal method comprising: a distortion removal step of performing distortion removal parallel to k pixels which exist in the same horizontal position in continuous different lines of an input image signal; and a vertical filtering step of performing vertical filtering for the distortion-removed k pixels to output at least two pixels. Therefore, the processing amount in the distortion removal process can be significantly reduced.

According to a sixteenth aspect of the present invention, there is provided an image signal distortion removal method comprising: a first distortion removal step of performing distortion removal parallel to k pixels which exist in the same horizontal position in continuous different lines of an input image signal, or k pixels including predetermined continuous pixels among k pixels which are the targets of the previous distortion removal, and next predetermined continuous pixels which are not the targets of the previous distortion removal; and a vertical filtering step of performing vertical filtering for the distortion-removed k pixels to output n pixels (n≧2). Therefore, the processing amount in the distortion removal process can be significantly reduced.

### BRIEF DESCRIPTION OF THE DRAWINGS

FIG. 1 is a block diagram illustrating an image signal distortion removal apparatus according to a first embodiment of the present invention.

FIG. 2 is a diagram for explaining a distortion removal process by a distortion removal circuit according to the first embodiment of the present invention.

FIG. 3 is a diagram illustrating a processing block to be subjected to the distortion removal process by the distortion removal circuit according to the first embodiment of the present invention.

FIG. 4 is a diagram illustrating processing areas in an original image to be processed by a distortion removal circuit and a vertical filter circuit according to the first embodiment of the present invention.

FIG. 5 is a diagram for explaining a four-tap filtering process.

FIG. 6 is a block diagram illustrating an image signal distortion removal apparatus according to a second embodiment of the present invention.

FIG. 7 is a diagram illustrating a processing block to be subjected to a distortion removal process by a distortion removal circuit according to the second embodiment of the present invention.

FIG. 8 is a diagram illustrating processing areas in an original image to be processed by a distortion removal circuit and a vertical filter circuit according to the second embodiment of the present invention.

FIG. 9 is a block diagram illustrating an image signal distortion removal apparatus according to a third embodiment of the present invention.

FIG. 10 is a flowchart illustrating a distortion removal process and a vertical filtering process according to the third embodiment of the present invention.

FIG. 11 is a flowchart illustrating processes for one frame according to the third embodiment of the present invention.

FIG. 12 is a diagram illustrating a processing area in an original image to he processed by a distortion removal circuit according to the third embodiment of the present invention.

FIG. 13 is a block diagram illustrating a conventional image signal distortion removal apparatus.

FIG. 14 is a diagram for explaining a distortion removal process by a distortion removal circuit of the conventional apparatus.

### DETAILED DESCRIPTION OF THE PREFERRED EMBODIMENTS

Hereinafter, preferred embodiments of the present invention will be described with reference to the drawings. However, the embodiments are merely examples, and the present invention is not restricted thereto.

[Embodiment 1]

Hereinafter, an image signal distortion removal apparatus and an image signal distortion removal method according to the first embodiment of the present invention will be described with reference to the drawings.

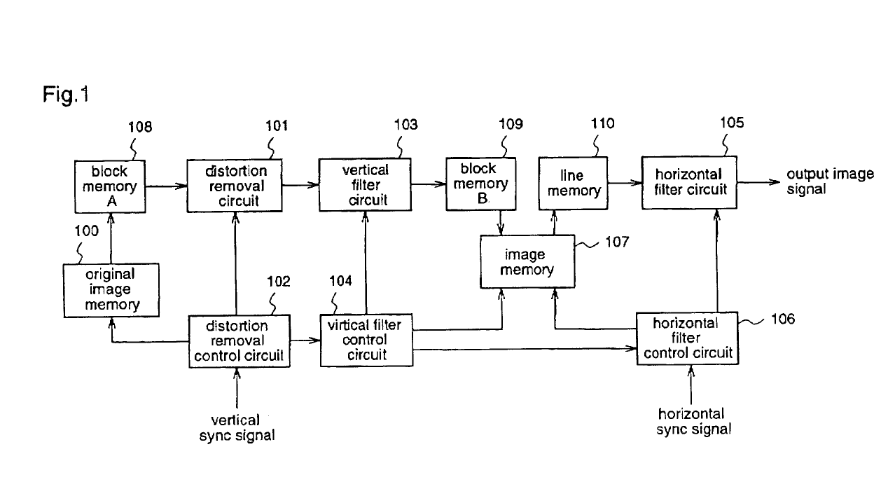

FIG. 1 is a block diagram illustrating the construction of the image signal distortion removal apparatus according to the first embodiment.

With reference to FIG. 1, the image signal distortion removal apparatus comprises an original image memory 100, a block memory A 108, a distortion removal circuit 101, a distortion removal control circuit 102, a vertical filter circuit 103, a block memory B 109, a vertical filter control circuit 104, a horizontal filter circuit 105, a horizontal filter control circuit 106, a line memory 110, and an image memory 107.

In the original image memory 100, a decoded original image is stored. The original image memory 100 is constituted as an external memory of the image signal distortion removal apparatus.

In the block memory A 108, the image signal read from the original image memory 100 is stored in block units. The block memory A 108 is constituted as an internal memory of the image signal distortion removal apparatus.

The distortion removal circuit 101 performs distortion removal for the image signal read from the block memory A108, and outputs the distortion-removed image signal to the vertical filter circuit 103. The distortion removal process is carried out in block units.

A processing block as a unit to be subjected to distortion removal by the distortion removal circuit 101 will be described with reference to FIG. 3.

Assuming that a target block to be processed by the vertical filter circuit 103 has the size of n×m pixels (n,m: natural numbers), an x line of upper reference pixels and a y line of lower reference pixels for vertical filtering according to the number of taps of the vertical filter circuit 103 are required as reference pixels. Therefore, a processing target of the distortion removal circuit 101 which processes the input image signal of the vertical filter circuit 103 is a block comprising (n+x+y)×m pixels. The size of this target block is the memory capacity of the block memory 108.

The distortion removal control circuit 102 receives a vertical sync signal, and outputs an instruction signal for instructing the original image memory 100 to read a block comprising N×M pixels (N,M: natural numbers) and output the block to the block memory A 108. Further, the distortion removal control circuit 102 outputs an instruction signal for instructing the block memory A 108 to output the stored image signal to the distortion removal circuit 101, and notifies the distortion removal circuit 101 of the position of the image signal to be output, in the original image. Further, the distortion removal control circuit 102 notifies the vertical filter control circuit 104 that the distortion removal process for one block by the distortion removal circuit 101 is completed.

The vertical filter 103 performs vertical filtering for the output signal of the distortion removal circuit 101 (distortion-removed image signal). The vertical filtering process is carried out in block units.

In the block memory B 109, the output signal from the vertical filter circuit 103 corresponding to one block is stored. The block memory B 109 is constituted as an internal memory of the image signal distortion removal apparatus.

The vertical filter control circuit 104 notifies the vertical filter circuit 103 of filter coefficients to be used for vertical filtering, and data position information. Further, the vertical filter control circuit 104 outputs an instruction signal for instructing the block memory B 109 to transfer the stored image signal to the image memory 107, and notifies the image memory 107 of memory access information of the image signal to be transferred (vertically-filtered image signal). Further, the vertical filter control circuit 104 notifies the horizontal filter control circuit 106 that the vertical filtering process for one frame by the vertical filter circuit 103 is completed.

In the line memory 110, the image signal corresponding to horizontal one line, which is read from the image memory 110, is stored. The line memory 110 is constituted as an internal memory of the image signal distortion removal apparatus.

The horizontal filter circuit 105 performs horizontal filtering for the image signal read from the line memory 110. The horizontal filtering process is carried out in line units.

The horizontal filter control circuit 106 outputs an instruction signal for instructing the image memory 107 to read the stored image signal in line units in synchronization with a horizontal sync signal, and output it to the line memory 110. Further, the horizontal filter control circuit 106 outputs an instruction signal for instructing the line memory 110 to output the stored image signal to the horizontal filter circuit 105. Further, the horizontal filter control circuit 106 outputs a signal indicating filter coefficients to be used for horizontal filtering and line position information, in line units, to the horizontal filter circuit 105.

In the image memory 107, the output signal from the vertical filter circuit 103 corresponding to one frame, i.e., the vertically-filtered image signal, is stored in block units. The image memory 107 outputs the stored image signal in line units to the line memory 110, on the basis of the instruction from the horizontal filter control circuit 106. The image memory 107 is constituted as an external memory of the image signal distortion removal apparatus.

Next, the image signal distortion removal method will be described.

When the vertical sync signal is input to the distortion removal control circuit 102, an image signal of N×M pixels corresponding to a target block is read from the original image memory 100 in accordance with the instruction from the distortion removal control circuit 102, and distortion attendant on decoding is removed from the read image signal by the distortion removal circuit 101.

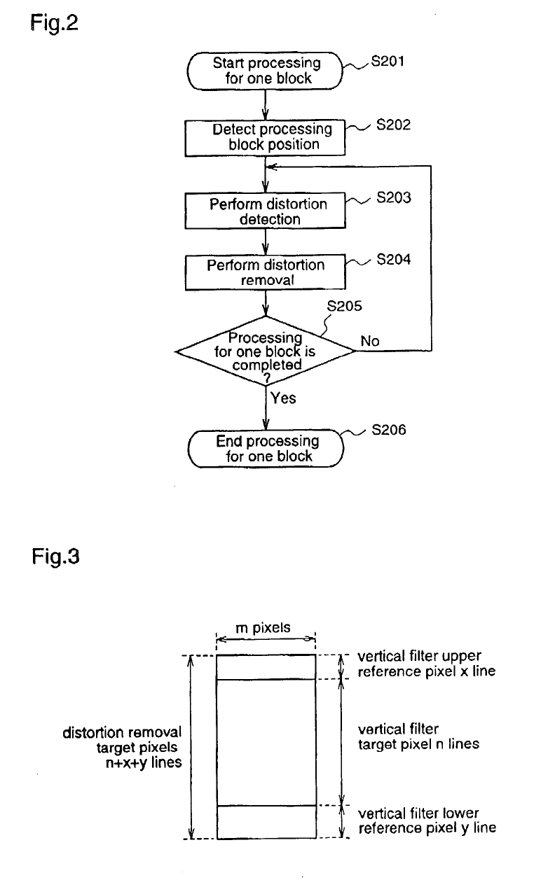

The distortion removal process by the distortion removal circuit 101 will be described with reference to FIG. 2.

Initially, when the distortion removal circuit 101 receives the notification of the target block position from the distortion removal control circuit 102, it starts distortion removal (S201). Then, the distortion removal circuit 101 recognizes a block boundary and an end point of image on the basis of the target block position, and detects the position of the target block in the original image which is notified from the distortion removal control circuit 102 at the start of distortion removal (S202). Thereafter, the distortion removal circuit 101 detects distortion of the image signal corresponding to the target block (S203), and removes the detected distortion from the target block with reference to the detected target block position (S204). The distortion detection and distortion removal (S203 and S204) are repeated until processing for one block is completed (S205). When the distortion removal process for one block is completed (S206), a distortion removal end signal is output from the distortion removal control circuit 102 to the vertical filter control circuit 104, and the filter coefficients to be used for vertical filtering by the vertical filter circuit 103 and the data position information are output from the vertical filter control circuit 104 to the vertical filter circuit 103. When there are unprocessed blocks remaining, an instruction signal for instructing updation of the target block position information is output from the distortion removal control circuit 102 to the distortion removal circuit 101, and the unprocessed image signal is read from the original image memory 100 in block units, and the same processing as described above is performed for each block.

The distortion-removed image signal is filtered in the vertical direction by the vertical filter circuit 103, and stored in the block memory B109. Then, the image signal is transferred on the basis of the instruction from the vertical filter control circuit 104 to be stored in a predetermined position in the image memory 107. When one frame of filtered image signal is stored, a vertical filtering end signal for one frame is output from the vertical filter control circuit 104 to the horizontal filter control circuit 106.

The image signal stored in the image memory 107 is read out in line units from the image memory 107 on the basis of the instruction from the horizontal filter control circuit 106, and stored in the line memory 109. The image signal stored in the line memory 109 is transferred in line units to the horizontal filter circuit 105 on the basis of the instruction from the horizontal filter control circuit 106, and horizontally filtered by the horizontal filter circuit 105 to be output as an output image signal.

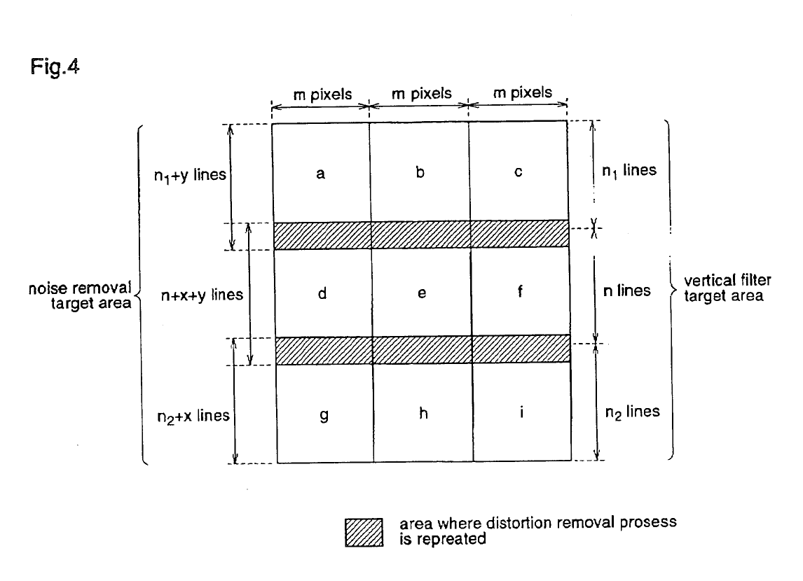

Next, processing areas of the original image to be processed by the distortion removal circuit 101 and the vertical filter circuit 103 will be described with reference to FIG. 4. In FIG. 4, the original image is divided into three parts in the vertical direction and the horizontal direction, respectively.

With reference to FIG. 4, blocks a, b, and c correspond to an upper portion of the original image Assuming that the processing range of the vertical filter circuit 103 is n₁ lines, the processing range of the distortion removal circuit 101 is n₁+y lines including the vertical filter lower reference line.

Further, blocks d, e, and f to be processed subsequently to the blocks a, b, and c correspond to the center of the original image. Assuming that the processing range of the vertical filter circuit 103 is n lines, the processing range of the distortion removal circuit 101 is n+x+y lines including the vertical filter upper and lower reference lines.

Further, blocks g, h, and i correspond to a lower portion of the original image signal. Assuming that the processing range of the vertical filter circuit 103 is n₂ lines, the processing range of the distortion removal circuit 101 is n₂+x lines including the vertical filter upper reference line.

In this way, between the blocks which are continuous in the vertical direction, the areas corresponding to the upper and lower reference lines (x+y lines) of the vertical filter circuit 103 overlap. The overlapping area depends on the number of taps of the vertical filter circuit 103.

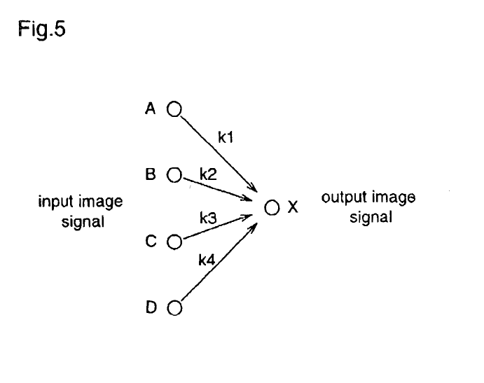

Now, a description will be given of the case where the vertical filter circuit 103 has four taps, with reference to FIG. 5. In FIGS. 5, A, B, C, and D are input pixels, k1, k2, k3, and k4 are the coefficients of the respective input pixels, and X is an output pixel.

One output pixel X can be calculated by an expression, A×k1+B×k2+C×k3+D×k4, using the four input pixels A˜D and the respective coefficients k1˜k4. That is, in order to obtain the output pixel X, the upper reference pixel A and the lower reference pixels C and D as well as the filter target pixel B are needed. Accordingly, when the vertical filter circuit 104 has four taps, the overlapping processing area x+y corresponds to three (≃1+2) lines.

The overlap of the processing area in the distortion removal process occurs when the block-by-block processing transits in the vertical direction, and it does not occur when the processing transits in the horizontal direction. Therefore, processing overhead depends on the number of lines (number of blocks) in the vertical direction and the number of taps of the vertical filter.

When the number of lines of the original image is N and the processing block is divided into M pieces in the vertical direction, the target area to be processed by the distortion removal circuit 101 is expressed by n₁+y+(n+x+y)×(M−2)+n₂+x=N+(M−1)×(x+y). For example, when the number N of lines of the original image signal in the vertical direction is 480, the number M of processing blocks is 10, and the vertical filter circuit 103 has four taps (x+y=3), the processing area of the distortion removal circuit 101 has 507 lines, and overhead of the distortion removal process becomes about 6%.

When the vertical filter circuit 103 has k taps, the overhead area of the distortion removal circuit 101 is (M−1)×(k−1) while the conventional overhead area is N×(k−1). Therefore, the ratio (M−1)/N of the overhead area becomes less than 1, and the influence of the number of taps on the processing amount can be reduced by the processing block construction.

At this time, the capacity of the block memory A 108 contained in the image signal distortion removal apparatus becomes (n+x+y)×z when the horizontal size of one block is z pixels, and the capacity of the block memory R 109 becomes n×r×z when the vertical magnification is r, whereby the capacity of the internal memory becomes ((1+r)n+x+y)×z. For example, assuming that the number N of lines of the original image signal in the vertical direction is 480, the number M of processing blocks is 10 (n=48), the vertical magnification is 1, and the horizontal size of one block is 8 pixels (z=8), the capacity of the internal memory becomes 792 pixels when the vertical filter circuit 103 has four taps (x+y=3).

In this way, when the vertical filter circuit 103 has four taps, the processing amount in the conventional line-by-line distortion removal process is increased by four times, while the processing amount in the block-by-block distortion removal process according to this first embodiment is increased only by 6%, whereby the processing amount of the distortion removal circuit 101 can be significantly reduced.

Furthermore, while in the conventional processing construction the capacity of the internal memory is 2880 (=720×4) pixels, the internal memory according to this first embodiment can be constructed so as to have a capacity of 1512 (=792+720) pixels of the block memory A 108, the block memory B 109, and the line memory 110, whereby the capacity of the internal memory can be reduced by about one-half.

The reduction in the processing amount of the distortion removal circuit 101 results in reductions in the overlapping distortion removal circuits 1˜N which are needed in the conventional distortion removal circuit 1301, and the line memory.

In the image signal distortion removal apparatus according to the first embodiment, the image signal that is read out in block units from the original image memory 100 is subjected to distortion removal and vertical filtering, and the processed signal is stored in the image memory 107. When processing for one frame is ended, the image signal is read out in line units from the image memory 107, subjected to horizontal filtering, and output as an output image to the outside. Therefore, in comparison with the conventional line-by-line processing, the processing amount in the distortion removal process can be significantly reduced, whereby the circuit scale of the distortion removal apparatus can be reduced.

[Embodiment 2]

Hereinafter, an image signal distortion removal apparatus and an image signal distortion removal method according to a second embodiment of the present invention will be described with reference to the drawings.

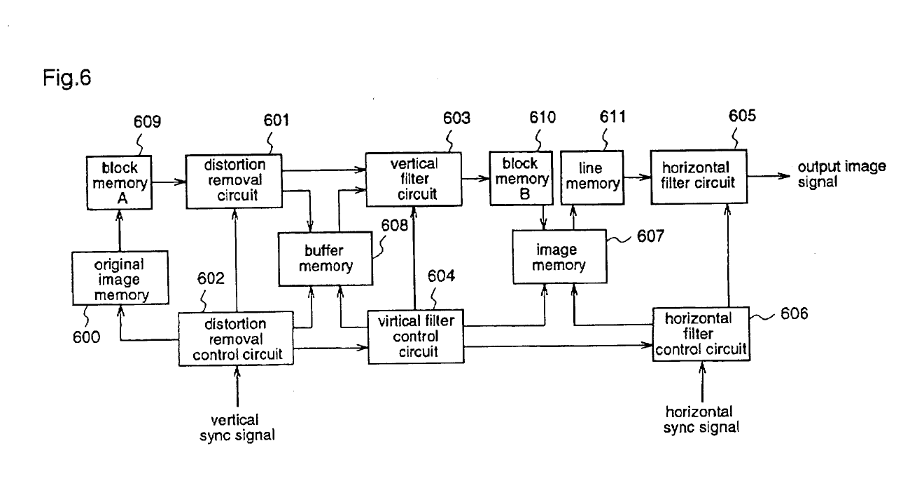

FIG. 6 is a block diagram illustrating the construction of the image signal distortion removal apparatus according to the second embodiment. With reference to FIG. 6, the image signal distortion removal apparatus comprises an original image memory 600, a block memory A 609, a distortion removal circuit 601, a distortion removal control circuit 602, a vertical filter circuit 603, a block memory B 610, a vertical filter control circuit 604, a horizontal filter circuit 605, a horizontal filter control circuit 606, a line memory 611, an image memory 607, and a buffer memory 608.

In the original image memory 600, a decoded original image is stored. The original image memory 600 is constituted as an external memory of the image signal distortion removal apparatus.

In the block memory A 609, the image signal read from the original image memory 600 is stored in block units. The block memory A 609 is constituted as an internal memory of the image signal distortion removal apparatus.

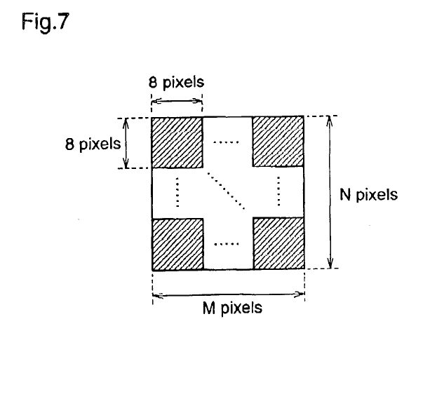

The distortion removal circuit 601 performs distortion removal from the image signal read from the block memory A 609, and outputs the image signal to a vertical filter circuit 603. Further, the distortion removal circuit 601 outputs a part of the distortion-removed image signal to a buffer memory 609 in accordance with an instruction from the distortion removal control circuit 602. The distortion removal process is carried out in block units. In this second embodiment, it is assumed that a processing block as a unit to be subjected to the distortion removal process is a DCT block comprising N×M pixels as shown in FIG. 7 (8 lines×8 pixels in FIG. 7). Therefore, when the distortion removal process (S204) is carried out with reference to the result of distortion detection (S203) performed in a DCT block as a processing unit of DCT in the decoding process, the distortion removal process is completed in the DCT block unit, whereby it becomes unnecessary to hold the result of distortion detection (S203) for the number of lines corresponding to the DCT block.

The distortion removal control circuit 602 receives a vertical sync signal, and outputs an instruction signal for instructing the original image memory 600 to read a block of N×M pixels (N,M=natural numbers) and output the block to the block memory A 609. Further, the control circuit 602 outputs an instruction signal for instructing the block memory A 609 to output the stored image signal to the distortion removal circuit 601, and notifies the distortion removal circuit 601 of the position of the output image signal in the original image. Furthermore, the control circuit 602 outputs an instruction signal for instructing the distortion removal circuit 601 to output a part of the distortion-removed image signal to the buffer memory 608. Furthermore, the control circuit 602 notifies the vertical filter control circuit 604 that the distortion removal process for one block by the distortion removal circuit 601 is ended.

The vertical filter circuit 603 performs vertical filtering for an image signal obtained by combining the output signal from the distortion removal circuit 601 and the output signal from the buffer memory 608. The vertical filtering process is carried out in block units.

In the block memory B 610, the output signal from the vertical filter circuit 603 is stored. The block memory B 610 is constituted as an internal memory of the image signal distortion removal apparatus.

When the vertical filter control circuit 604 is notified by the distortion removal control circuit 602 that the distortion removal process for one block is ended, the control circuit 604 outputs an instruction signal for instructing the buffer memory 608 to read a predetermined signal from among the stored image signals and output it to the vertical filter circuit 603, and notifies the vertical filter circuit 603 of filter coefficients to be used for vertical filtering, and data position information. Further, the control circuit 604 notifies the image memory 607 of memory access information of the image signal which has been vertically filtered. Furthermore, the control circuit 604 notifies a horizontal filter control circuit 606 that the vertical filtering process for one frame by the vertical filter circuit 603 is ended.

The horizontal filter circuit 605 performs horizontal filtering for the image signal read from a line memory 611.

The horizontal filter control circuit 606 is operated with an input of a horizontal sync signal, and outputs an instruction signal for instructing the image memory 607 to read the stored image signal in line units in synchronization with the horizontal sync signal, and output it to the line memory 611. Further, the control circuit 606 outputs an instruction signal for instructing the line memory 611 to output the stored image signal in line units to the horizontal filter circuit 605, and outputs a signal indicating filter coefficients to be used for horizontal filtering of the output image signal and line position information, in line units, to the horizontal filter circuit 605.

In the line memory 611, the image signal corresponding to horizontal one line, which is read from the image memory 607, is stored. The line memory 611 is constituted as an internal memory of the image signal distortion removal apparatus.

In the image memory 607, the output signal from the vertical filter circuit 603 corresponding to one frame, i.e., the image signal which has been vertically filtered, is stored in block units. The image memory 607 outputs the stored image signal in line units to the line memory 611 on the basis of the instruction from the horizontal filter control circuit 606. The image memory 607 is constituted as an external memory of the image signal distortion removal apparatus.

In the buffer memory 608, the distortion-removed image signal outputted from the distortion removal circuit 601 is written in accordance with the instruction from the distortion removal control circuit 602. Further, the buffer memory 608 outputs a predetermined image signal to the vertical filter 603 in accordance with the instruction from the vertical filter control circuit 604. The buffer memory 608 is constituted as an external memory of the image signal distortion removal apparatus.

Next, the image signal distortion removal method will be described.

When a vertical sync signal is input to the distortion removal control circuit 602, an image signal corresponding to a block comprising N×M pixels is read from the original image memory 600 in accordance with the instruction from the distortion removal control circuit 602. Then, distortion attendant on the decoding process is removed from the read image signal by the distortion removal circuit 601. The process of reading the image signal from the original image memory 600 in block units proceeds in the horizontal direction, whereby the whole original image is subjected to distortion removal.

When the distortion removal process for one block is ended, a part of the distortion-removed image signal is stored in the buffer memory 608, and a distortion removal end signal is output from the distortion removal control circuit 602 to the vertical filter control circuit 604. Then, an instruction signal for instructing the buffer memory 608 to read predetermined data is output from the vertical filter control circuit 604 to the buffer memory 608, and filter coefficients to be used for vertical filtering and data position information are output from the vertical filter control circuit 604 to the vertical filter circuit 603.

In the vertical filter circuit 603, vertical filtering is performed for the signal obtained by combining the output signal from the distortion removal circuit 601 and the signal read from the buffer memory 608, and the vertically-filtered signal is stored in a predetermined position in the image memory 607 on the basis of the instruction from the vertical filter control circuit 604. When the filtered image signal corresponding to one frame is stored, a processing end signal for one frame is output from the vertical filter control circuit 604 to the horizontal filter control circuit 606.

Then, the image signal stored in the image memory 607 is read in line units from the image memory 607 in accordance with the instruction from the horizontal filter control circuit 606 to be stored in the line memory 611. The image signal stored in the line memory 611 is transferred in line units to the horizontal filter circuit in accordance with the instruction from the horizontal filter control circuit 606, subjected to horizontal filtering by the horizontal filter circuit 605, and output as an output image signal.

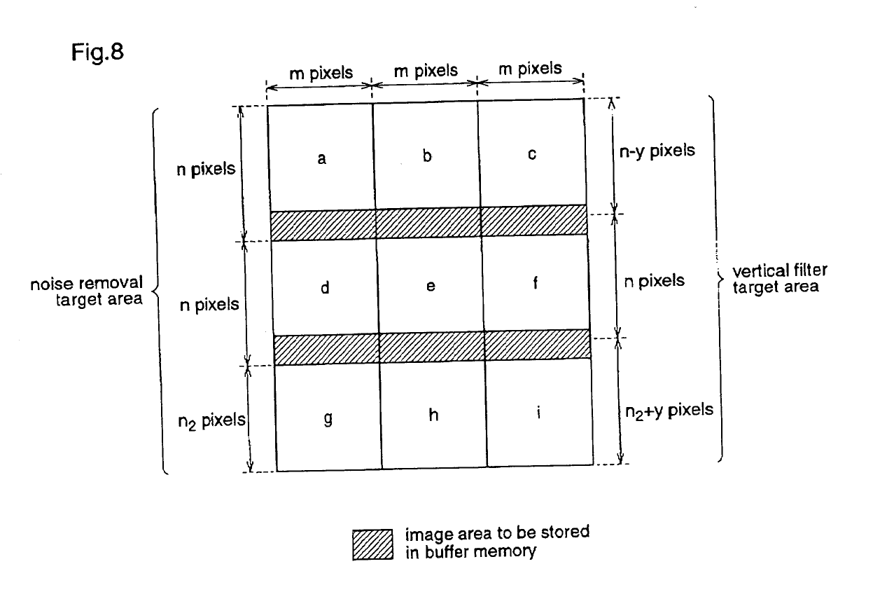

Next, the processing area in the original image to be processed by the distortion removal circuit 601 and the vertical filter circuit 603 will be described with reference to FIG. 8. In FIG. 8, the processing area is divided into three parts in the vertical direction and the horizontal direction, respectively.

Blocks a, b, and c correspond to an upper portion of the original image. Assuming that the processing range of the block a by the distortion removal circuit 601 is m pixels×n lines corresponding to a DCT block, the processing range by the vertical filter circuit 603 becomes m pixels×(n−y) lines excluding a vertical filter lower reference line. The lower m pixels×(x+y) lines of the block a are stored in the buffer memory 608 by the distortion removal control circuit 602. The blocks b and c are subjected to similar processes.

Blocks d, e, and f to be processed subsequently to the blocks a, b, and c are located in the center of the original image. Assuming that the processing range of the distortion removal circuit 601 is n lines, the processing range of the vertical filter 603 is also n lines. The blocks d, e, and f are combined with the lower x+y lines of the blocks a, b, and c stored in the butter memory 608, and the combined image signal is input to the vertical filter circuit 603 by the vertical filter control circuit 604.

Blocks g, h, and i correspond to a lower portion of the original image. Assuming that the processing range of the distortion removal circuit 601 is n₂ lines, the processing range of the vertical filter circuit 603 becomes n₂+y lines including the vertical filter lower reference lines y in the blocks d, e, and f. At this time, the areas to be processed by the distortion removal circuit 601 do not overlap between the processing blocks that are continuous in the vertical direction. Accordingly, the buffer memory 608 needs a capacity for x|y lines.

For example, assuming that the number of lines in the original image is N and the processing block is divided into M in the vertical direction, the target area to be processed by the distortion removal circuit 601 becomes n₁+y+n×(M−2)+n₁−y=N, and the target areas to be processed by the distortion removal circuit 601 do not overlap, whereby occurrence of processing overhead can be completely prevented.

In the image signal distortion removal apparatus according to the second embodiment, the image signal which is read in block units from the original image memory 600 is subjected to distortion removal, and a part of the distortion-removed image signal is stored as a reference image in the buffer memory 608. Then, the distortion-removed image signal and the reference image are combined, and the combined signal is filtered in the vertical direction and stored in the image memory 607. When the processing for one frame is completed, the image signal is read in line units from the image memory 607, subjected to horizontal filtering, and output as an output image to the outside. Therefore, the target areas to be processed by the distortion removal circuit 601 do not overlap, whereby occurrence of processing overhead can be completely prevented. As a result, the processing amount in the distortion removal process is significantly reduced, and the circuit scale of the image signal distortion removal apparatus is reduced.

[Embodiment 3]

Hereinafter, an image signal distortion removal apparatus and an image signal distortion removal method according to a third embodiment of the present invention will be described with reference, to the drawings.

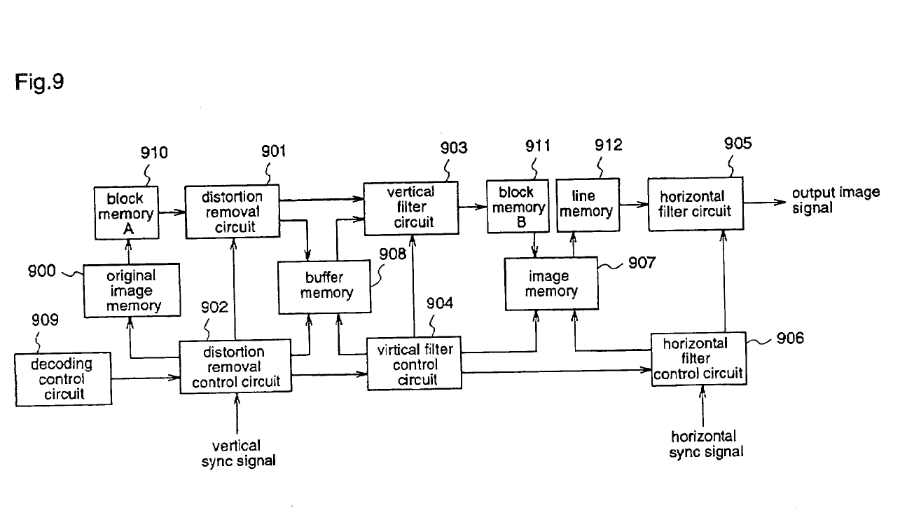

FIG. 9 is a block diagram illustrating the construction of the image signal distortion removal apparatus according to the third embodiment. With reference to FIG. 9, the image signal distortion removal apparatus comprises an original image memory 900, a block memory A 910, a distortion removal circuit 901, a distortion removal control circuit 902, a vertical filter circuit 903, a block memory B 911, a vertical filter control circuit 904, a horizontal filter circuit 905, a horizontal filter control circuit 906, a line memory 912, an image memory 907, a buffer memory 908, and a decoding control circuit 909.

In the original image memory 900, a decoded original image is stored. The original image memory 900 is constituted as an external memory of the image signal distortion removal apparatus.

In the block memory A 910, the image signal read from the original image memory 900 is stored in block units. The block memory A 910 is constituted as an internal memory of the image signal distortion removal apparatus.

The distortion removal circuit 901 performs distortion removal for the image signal read from the block memory A 910, and outputs the distortion-removed image signal to the vertical filter circuit 903. Further, the distortion removal circuit 901 outputs a part of the distortion-removed image signal to the buffer memory 908 in accordance with an instruction from the distortion removal control circuit 902. The distortion removal process is carried out in block units.

The distortion removal control circuit 902 is operated with an input of a vertical sync signal, and determines a processing area so as to divide the original image into the processing area and a non-processing area, on the basis of the progress of the decoding process, which is notified from the decoding control circuit 909. Then, the distortion removal control circuit 902 outputs an instruction signal for instructing the original image memory 900 to read the original image corresponding to the processing target area in block units each comprising N×M pixels (N,M=natural numbers), and input the read image to the block memory A 910. Further, the control circuit 902 outputs an instruction signal for instructing the block memory A 910 to output the stored image signal to the distortion removal circuit 901, and notifies the distortion removal circuit 901 of the position of the output image signal in the original image. Further, the control circuit 902 outputs an instruction signal for instructing the distortion removal circuit 901 to output a part of the distortion-removed image signal to the buffer memory 908. Further, the control circuit 902 notifies the vertical filter control circuit 904 that the distortion removal process for one block by the distortion removal circuit 901 is completed.

The vertical filter circuit 903 performs vertical filtering on the output signal from the distortion removal circuit 901 and the output signal from the buffer memory 908. The vertical filtering process is carried out in block units.

In the block memory B 911, the output signal from the vertical filter circuit 903 is stored. The block memory B 911 is constituted as an internal memory of the image signal distortion removal apparatus.

When the vertical filter control circuit 904 is notified by the distortion removal control circuit 902 that the distortion removal process for one block is completed, the control circuit 904 outputs an instruction signal for instructing the buffer memory 908 to read a predetermined signal from among the stored image signals and output it to the vertical filter circuit 903, and notifies the vertical filter circuit 903 of filter coefficients to be used for vertical filtering and data position information. Further, the control circuit 904 notifies the horizontal filter control circuit 906 that the vertical filtering process for one frame by the vertical filtering circuit 903 is completed.

The horizontal filter circuit 905 performs horizontal filtering for the image signal read from the line memory 912. The horizontal filtering process is carried out in line units.

The horizontal filter control circuit 906 is operated with an input of a horizontal sync signal, and outputs an instruction signal for instructing the image memory 907 to read the stored image signal in line units and output it to the line memory 912. Further, the control circuit 906 outputs an instruction signal for instructing the line memory 912 to output the stored image signal in line units to the horizontal filter circuit 905, and outputs a signal indicating filter coefficients to be used for horizontal filtering of the output image signal and line position information, in line units, to the horizontal filter circuit 905.

In the line memory 912, the image signal corresponding to one horizontal line, which is read from the image memory 907, is stored. The line memory 912 is constituted as an internal memory of the image signal distortion removal apparatus.

In the image memory 907, the output signal from the vertical filter circuit 903, that is, the vertically-filtered image signal among the already-processed signals in the decoding-completed area in the divided original image, is stored in block units. The image memory 907 outputs the stored image signal in line units to the line memory 912 on the basis of the instruction from the horizontal filter control circuit 906.

In the buffer memory 908, the distortion-removed image signal outputted from the distortion removal circuit 901 is written in accordance with the instruction from the distortion removal control circuit 902. Further, the buffer memory 908 outputs a predetermined image signal to the vertical filter circuit 903 in accordance with the instruction from the vertical filter control circuit 904. The buffer memory 908 is constituted as an external memory of the image signal distortion removal apparatus.

The decoding control circuit 909 controls decoding of the coded signal, and notifies the distortion removal control circuit 902 of the decoding-completed area.

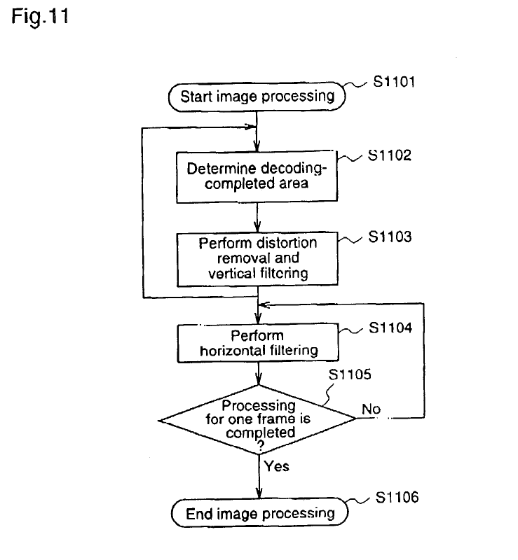

Hereinafter, the image signal distortion removal method will be described with reference to FIG. 11.

First of all, image processing is started with an input of a vertical sync signal (S1101). When the decoding control circuit 909 notifies the distortion removal control circuit 902 of an area where decoding has been completed, the distortion removal control circuit 902 determines a processing target area (decoding-completed area) in the original image stored in the original image memory 900 (S1102).

Then, among the image signals corresponding to the blocks of N×M pixels, the image signals in the determined decoding-completed area are read out in block units in the vertical direction from the original image memory 900. The read image signals are subjected to distortion removal and vertical filtering (S1103).

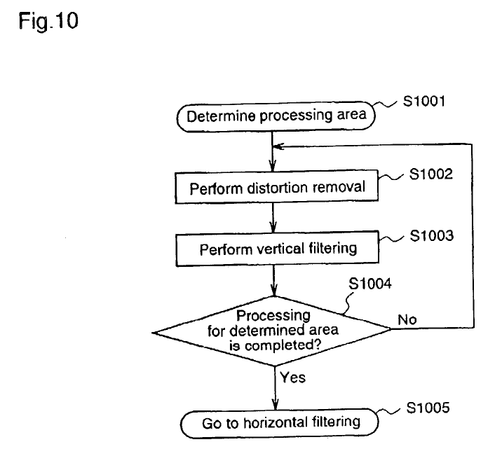

The distortion removal process and the vertical filtering process will be described in detail with reference to FIG. 10.

When the processing area is determined on the basis of the notification of the decoding-completed area from the decoding control circuit 909 (S1001), the signal which is vertically read out in block units from the original image memory 900 is subjected to distortion removal (S1002). When the distortion removal process for one block is completed, a part of the distortion-removed image signal is stored in the buffer memory 908 as a reference image. At this time, a distortion removal end signal is output from the distortion removal control circuit 902 to the vertical filter control circuit 904. Thereafter, an instruction signal instructing readout of predetermined data is output from the vertical filter control circuit 904 to the buffer memory 908, and filter coefficients to be used for vertical filtering and data position information are output from the vertical filter control circuit 904 to the vertical filter circuit 903, whereby a signal obtained by combining the output signal from the distortion removal circuit 901 and the signal read from the buffer memory 908 is subjected to vertical filtering (S1003). Then, the vertically-filtered signal is stored in a predetermined position in the image memory 907 on the basis of an instruction from the vertical filter control circuit 904. After the whole determined area which has already been decoded is subjected to similar processes (S1004), a processing end signal for the already-decoded area of the divided original image is output from the vertical filter control circuit 904 to the horizontal filter control circuit 906. Then, the image signal stored in the image memory 907 is read out in line units from the image memory 907 on the basis of an instruction from the horizontal filter control circuit 906 to be output to the horizontal filter circuit 905 through the line memory 912 (S1005).

Next, in the horizontal filter circuit 905, the image signal which is read out in line units from the image memory 907 is subjected to horizontal filtering (S1104). Further, simultaneously with the horizontal filtering, a new processing area is determined in accordance with a notification from the decoding control circuit 909 (S1102), and the new processing area is subjected to distortion removal and vertical filtering (S1103). Thereafter, similar processes are repeated to process the whole frame (S1105) to complete the image processing (S1106).

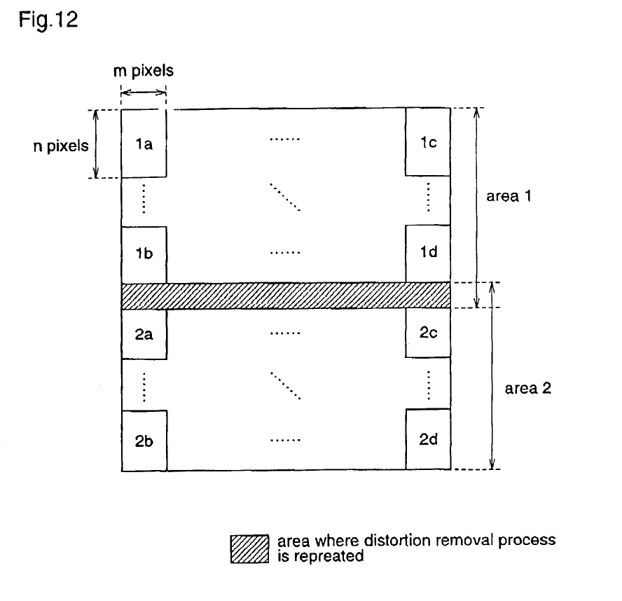

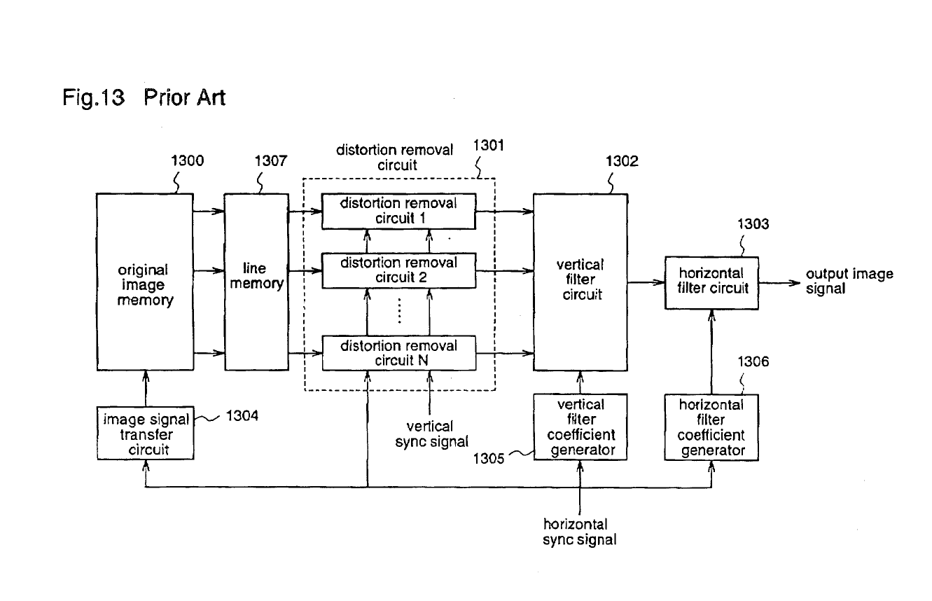

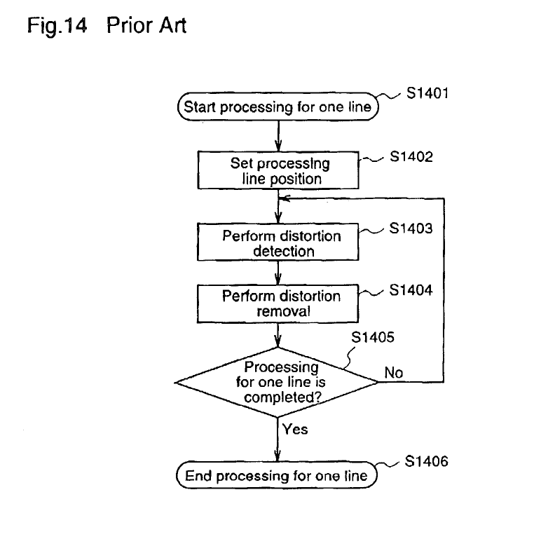

Next, an area in the original image to be processed by the distortion removal circuit 901 will be described with reference to FIG. 12. A description will be given of a case where the original image is divided into an area 1 and an area 2 on the basis of a decoding end signal supplied from the decoding control circuit 909. In FIG. 12, blocks 1a˜1d and 2a˜2d are blocks to be processed by the distortion removal circuit 901.

After performing distortion removal for the block 1a, the distortion removal control circuit 902 controls the processing in the vertical direction up to the block 1b. Then, the control circuit 902 makes the same processing transit in the horizontal direction to process the blocks 1c˜1d. Subsequently, the distortion removal control circuit 902 processes the block 2a in the area 2 including the lower end x+y lines of the area 1, and thereafter, controls the processing in the vertical direction up to block 2b. Then, the control circuit 902 makes the same processing transit in the horizontal direction to process the blocks 2c˜2d. Therefore, while in the second embodiment the buffer memory 608 needs a capacity for x+y lines with respect to the original image, in this third embodiment the image signal to be stored in the buffer memory 908 corresponds to m×(x+y) pixels which are vertical filter upper and lower reference pixels to be used for onetime processing, whereby the capacity of the buffer memory 908 can be reduced. Furthermore, since the distortion removal control circuit 902 divides the processing image in the horizontal direction in accordance with the progress of the decoding process which is notified from the decoding control circuit 909, overhead of the distortion removal process (process for x+y lines) can be minimized. Further, since the horizontal filter control circuit 906 starts horizontal filtering for each of the divided areas, it is possible to avoid adverse effect such as interruption of the output image when the progress of decoding is slow.

In the image signal distortion removal apparatus according to the third embodiment, a processing area in the original image is determined in accordance with the progress of decoding, and the image signal within the processing area is vertically read out in block units from the original image memory 900 to be subjected to distortion removal, vertical filtering, and horizontal filtering. Therefore, the capacity of the buffer memory 908 is reduced, and overhead of the distortion removal process is minimized, and further, adverse effect such as interruption of the output image is avoided when the progress of decoding is slow. As a result, the proccessability of the image signal distortion removal apparatus can be enhanced.

What is claimed is:

1. An image signal distortion removal apparatus for removing distortion attendant on decoding from a decoded original image, comprising:
an original image memory for storing the original image;
a first block memory for storing an image signal read from the original image memory in block units;
a distortion removal circuit for performing distortion removal in block units for the image signal read from the first block memory;
a distortion removal control circuit for controlling the readout of the image signal from the original image memory to the first block memory, and the distortion removal by the distortion removal circuit;
a vertical filter circuit for performing vertical filtering in block units for the output signal of the distortion removal circuit;
a second block memory for storing one block of output signal from the vertical filter circuit;
an image memory for storing one frame of output signal from the vertical filter circuit;
a vertical filter control circuit for controlling the vertical filtering by the vertical filter circuit, and the transfer of the image signal from the second block memory to the image memory;
a line memory for storing one horizontal line of image signal read from the image memory;
a horizontal filter circuit for performing horizontal filtering in line units for the image signal stored in the line memory; and
a horizontal filter control circuit for controlling the readout of the image signal from the image memory, and the horizontal filtering by the horizontal filter circuit.

2. An image signal distortion removal apparatus as defined in claim 1 further comprising a buffer memory for storing a part of the output signal from the distortion removal circuit as a reference image, said buffer memory being placed between the distortion removal circuit and the vertical filter circuit;
wherein said vertical filter circuit performs vertical filtering for an image signal obtained by containing the output signal from the distortion removal circuit and the reference image stored in the buffer memory.

3. An image signal distortion removal apparatus as defined in claim 1 or 2, wherein said distortion removal control circuit instructs the original image memory to read a block comprising N×M pixels (N,M: natural numbers) in the horizontal direction, and input the block into the first block memory.

4. An image signal distortion removal apparatus as defined in claim 2, wherein said distortion removal control circuit instructs the original image memory to read an image block comprising a DCT block which is a processing unit of discrete cosine transformation in the decoding process from the original image in the vertical direction, and input the block into the first block memory.

5. An image signal distortion removal apparatus as defined in claim 2, wherein said distortion removal control circuit determines a processing area so that the original image is divided into the processing area and a non-processing area in the vertical direction, instructs the distortion removal circuit to successively perform distortion removal in block units each comprising N×M pixels (N,M: natural numbers) in the vertical direction, and outputs a distortion removal end signal to the vertical filter control circuit when the distortion removal within the processing area is ended.

6. An image signal distortion removal apparatus as defined in claim 5, wherein said distortion removal control circuit determines a processing area in the original image on the basis of the progress of the decoding process.

7. An image signal distortion removal apparatus as defined in claim 5 or 6, wherein
said vertical filter control circuit outputs a vertical filtering end signal to the horizontal filter control circuit when vertical filtering for the image signal in the processing area is ended;
on receipt of the vertical filtering end signal, said horizontal filter control circuit instructs the image memory to read the stored image signal in line units, and input it to the horizontal filter circuit; and
said distortion removal control circuit determines a new processing area in the original image corresponding to the non-processing area on the basis of the progress of the decoding process, and instructs the original image memory to read the image signal in the processing area in block units in the vertical direction, and input it to the distortion removal circuit.

8. An image signal distortion removal method for removing distortion from a decoded image signal which is stored in an original image memory, comprising:
a distortion removal step of reading the image signal from the original image memory in block units, and performing distortion removal from the image signal;
a vertical filtering stop of filtering the distortion-removed image signal in the vertical direction, and storing the image signal into an image memory; and
a horizontal filtering step of reading the image signal stored in the image memory in line unit, vertically filtering the image signal, and outputting the vertically-filtered image signal as an output image signal.

9. An image signal distortion removal method as defined in claim 8 further comprising a step of storing a part of the distortion-removed image signal as a reference image into a buffer memory;
wherein said vertical filtering step performs vertical filtering for an image signal obtained by combining the distortion-removed image signal and the reference image.

10. An image signal distortion removal method as defined in claim 8 or 9, wherein said distortion removal step includes;
a readout step of reading a block comprising N×M pixels (N,M: natural numbers) as a processing target block from the original image memory in the vertical direction;
a position detection step of detecting the position of the processing target block in the original image;
a distortion detection step of detecting distortion of the image signal corresponding to the processing target block; and
a distortion removal step of removing the detected distortion of the image signal from the processing target block with reference to the detected position of the processing target block.

11. An image signal distortion removal method as defined in claim 9, wherein said distortion removal step includes:
a readout step of reading a DCT block which is a processing unit of discrete cosine transformation in the decoding process, as a processing target block, from the original image memory in the horizontal direction;
a position detection step of detecting the position of the processing target block in the original image;
a distortion detection step of detecting distortion of the image signal corresponding to the processing target block; and
a distortion removal step of removing the detected distortion of the image signal from the processing target block with reference to the detected position of the processing target block.

12. An image signal distortion removal method as defined in claim 9, wherein said distortion removal step includes:
a processing area determination step of determining a processing area so that the original image is divided into the processing area and a non-processing area in the vertical direction; and
an intra-processing-area distortion removal step of performing distortion removal in block units, within the processing area in the vertical direction.

13. An image signal distortion removal method as defined in claim 12, wherein said processing area determination step determines a processing area in the original image on the basis of information relating to the progress of the decoding process.

14. An image signal distortion removal method as defined in claim 12 or 13, wherein said distortion removal step performs horizontal filtering for the image signal in the processing area which has been subjected to distortion removal and vertical filtering and, simultaneously, determines a new processing area in the non-processing area on the basis of the progress of the decoding process, and performs distortion removal and vertical filtering for the new processing area.

15. An image signal distortion removal method comprising:
a distortion removal step of performing distortion removal parallel to k pixels which exist in the same horizontal position in continuous different lines of an input image signal; and
a vertical filtering step of performing vertical filtering for the distortion-removed k pixels to output at least two pixels.

16. An image signal distortion removal method comprising:
a first distortion removal step of performing distortion removal parallel to k pixels which exist in the same horizontal position in continuous different lines of an input image signal, or k pixels including predetermined continuous pixels among k pixels which are the targets of the previous distortion removal, and next predetermined continuous pixels which are not the targets of the previous distortion removal; and
a vertical filtering step of performing vertical filtering for the distortion-removed k pixels to output n pixels (n≧2).
